(19) United States
(12) Patent Application Publication
(10) Pub. No.: US 2024/0242704 A1
(43) Pub. Date: Jul. 18, 2024

(54) Systems and Methods for Optimizing Voice Notifications Provided by Way of a Hearing Device

(71) Applicant: SONOVA AG, Staefa (CH)

(72) Inventors: Gabriel Perez de la Sota, Maennedorf (CH); Marius Ruefenacht, Gockhausen (CH)

(73) Assignee: SONOVA AG, Staefa (CH)

(21) Appl. No.: 18/097,955

(22) Filed: Jan. 17, 2023

(51) Int. Cl. G10L 13/033; H04R 25/00

(52) U.S. Cl. CPC G10L 13/0335; H04R 25/55; H04R 25/70; H04R 2225/55

(57) ABSTRACT

An exemplary system includes a memory storing instructions and a processor communicatively coupled to the memory and configured to execute the instructions to perform a process. The process may comprise accessing a hearing loss profile of a user of a hearing device, determining, based on the hearing loss profile of the user, one or more acoustic parameters for voice notifications, and directing the hearing device to apply the one or more acoustic parameters to a voice notification to be presented to the user by way of the hearing device.

### BACKGROUND INFORMATION

Hearing devices (e.g., hearing aids) are used to improve the hearing capability and/or communication capability of users of the hearing devices. Such hearing devices are configured to process a received input sound signal (e.g., ambient sound) and provide the processed input sound signal to the user (e.g., by way of a receiver (e.g., a speaker) placed in the user's ear canal or at any other suitable location).

In conventional hearing devices, sound notifications (e.g., jingles, tunes, chimes, etc.) are typically used to inform users regarding the status of the hearing devices. In addition, sound notifications may be used to provide acoustical feedback to signal a successful interaction (e.g., a volume change) by a user. To improve user experience, voice notifications have been proposed as an alternative way to provide status updates and/or other notifications to users by way of hearing devices. However, it may be difficult for users of hearing devices to perceive certain types of voice notifications. In addition, hearing devices typically have limited storage available for voice notifications, which limits the number of possible notifications and/or voice type options that the hearing devices may use. Accordingly, there remains room to improve voice notifications provided to users by way of hearing devices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing device management system that may be implemented according to principles described herein.

FIG. 2 illustrates an exemplary implementation of the hearing device management system of FIG. 1 according to principles described herein.

FIGS. 3-5 illustrate exemplary flow diagrams that may be implemented according to principles described herein.

FIG. 6 illustrates an exemplary method according to principles described herein.

FIG. 7 illustrates an exemplary computing device according to principles described herein.

### DETAILED DESCRIPTION

Systems and methods for optimizing voice notifications are described herein. As will be described in more detail below, an exemplary system may comprise a memory storing instructions and a processor communicatively coupled to the memory and configured to execute the instructions to perform a process. The process may comprise accessing a hearing loss profile of a user of a hearing device, determining, based on the hearing loss profile of the user, one or more acoustic parameters for voice notifications, and directing the hearing device to apply the one or more acoustic parameters to a voice notification to be presented to the user by way of the hearing device.

By using systems and methods such as those described herein, it may be possible to facilitate a user of a hearing device more easily perceiving voice notifications presented by way of the hearing device to the user. For example, systems and methods such as those described herein may be configured to leverage a hearing loss profile of a user to determine one or more acoustic parameters to use for voice notifications. In so doing, systems and methods such as those described herein may provide a user of a hearing device with a customized and improved hearing experience with respect to voice notifications that may be provided to the user by way of the hearing device. In addition, systems and methods such as those described herein may facilitate selecting and/or customizing types of voices that may be used for voice notifications. Other benefits of the systems and methods described herein will be made apparent herein.

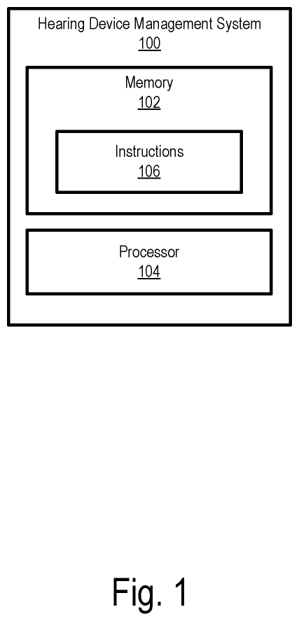

FIG. 1 illustrates an exemplary hearing device management system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, acoustic parameter data, machine learning data, voice notification information, graphical user interface content, and/or any other suitable data.

Processor 104 may be configured to perform (e.g., execute instructions 106 stored in memory 102 to perform) various processing operations associated with optimizing voice notifications provided by way of a hearing device. For example, processor 104 may perform one or more operations described herein to determine, based on a hearing loss profile of a user, one or more acoustic parameters for voice notifications and direct the hearing device to apply the one or more acoustic parameters to a voice notification to be presented to the user by way of the hearing device. These and other operations that may be performed by processor 104 are described herein.

As used herein, a “hearing device” may be implemented by any device or combination of devices configured to provide or enhance hearing to a user. For example, a hearing device may be implemented by a hearing aid configured to amplify audio content to a recipient, a sound processor included in a cochlear implant system configured to apply electrical stimulation representative of audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. In some examples, a hearing device may be implemented by an in-the-ear (“ITE”) component configured to at least partially be inserted within an ear canal of a user. In some examples, a hearing device may include a combination of an ITE component, a BTE housing, and/or any other suitable component.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

In some examples, a hearing device may additionally or alternatively include earbuds, headphones, hearables (e.g., smart headphones), and/or any other suitable device that may be used to provide voice notifications to a user. In such examples, the user may correspond to either a hearing impaired user or a non-hearing impaired user.

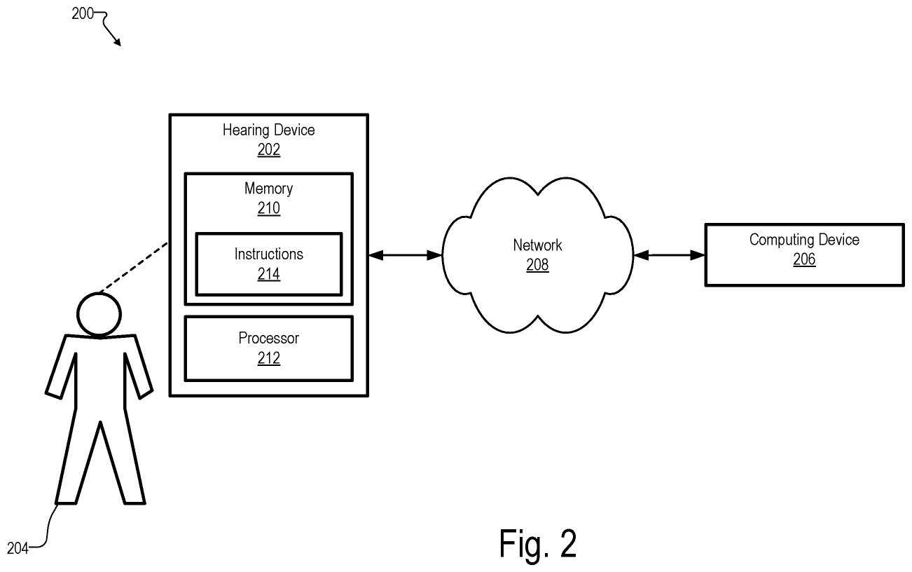

System 100 may be implemented in any suitable manner. For example, system 100 may be implemented by a computing device and/or a hearing device that is communicatively coupled in any suitable manner to the computing device. To illustrate an example, FIG. 2 shows an exemplary implementation 200 in which system 100 may be provided in certain implementations. As shown in FIG. 2, implementation 200 includes a hearing device 202 that is associated with a user 204 and that is communicatively coupled to a computing device 206 by way of a network 208.

Hearing device 202 may correspond to any suitable type of hearing device such as described herein. Hearing device 202 may include, without limitation, a memory 210 and a processor 212 selectively and communicatively coupled to one another. Memory 210 and processor 212 may each include or be implemented by hardware and/or software components (e.g., processors, memories, communication interfaces, instructions stored in memory for execution by the processors, etc.). In some examples, memory 210 and processor 212 may be housed within or form part of a BTE housing. In some examples, memory 210 and processor 212 may be located separately from a BTE housing (e.g., in an ITE component). In some alternative examples, memory 210 and processor 212 may be distributed between multiple devices (e.g., multiple hearing devices in a binaural hearing system) and/or multiple locations as may serve a particular implementation.

Memory 210 may maintain (e.g., store) executable data used by processor 212 to perform any of the operations associated with hearing device 202. For example, memory 210 may store instructions 214 that may be executed by processor 212 to perform any of the operations associated with hearing device 202 assisting a user in hearing. Instructions 214 may be implemented by any suitable application, software, code, and/or other executable data instance.

Memory 210 may also maintain any data received, generated, managed, used, and/or transmitted by processor 212. For example, memory 210 may maintain any suitable data associated with a hearing loss profile of a user, voice notification information (e.g., a plurality of pre-recorded voice notifications), machine learning algorithms, and/or hearing device function data. Memory 210 may maintain additional or alternative data in other implementations.

Processor 212 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 212 may be implemented by any suitable combination of hardware and software. In certain examples, processor 218 may correspond to or otherwise include one or more deep neural network (“DNN”) chips configured to perform any suitable machine learning operation such as described herein.

Computing device 206 may include or be implemented by any suitable type of computing device or combination of computing devices as may serve a particular implementation. In certain examples, computing device 206 may be implemented by any suitable device at a fitting facility where a hearing care professional (e.g., an audiologist) fits hearing device 202 to user 204. In such examples, computing device 206 may correspond to a laptop computer, a desktop computer, a tablet computer, and/or any other suitable computing device that may be configured to form a fitting operation for hearing device 202. In such examples, computing device 206 may be configured to perform any suitable operations such as those described herein to optimize voice notifications to be presented to user 204 by way of hearing device 202.

In certain alternative implementations, computing device 206 may correspond to an external device that is configured to transmit one or more voice notifications to hearing device 202 to be presented to user 204 by way of hearing device 202. In such examples, computing device 206 may correspond to a TV, a smart speaker (e.g., Amazon Echo), a laptop computer, a desktop computer, a tablet computer, a smartphone, and/or any other suitable computing device or combination thereof that may be configured to transmit voice notifications to hearing device 202.

Computing device 206 may include or be implemented by any suitable hardware and/or software components (e.g., processors, memories, communication interfaces, instructions stored in memory for execution by the processors, etc.).

Network 208 may include, but is not limited to, one or more wireless networks (Wi-Fi networks), wireless communication networks, mobile telephone networks (e.g., cellular telephone networks), mobile phone data networks, broadband networks, narrowband networks, the Internet, local area networks, wide area networks, and any other networks capable of carrying data and/or communications signals between hearing device 202 and computing device 206. In certain examples, network 208 may be implemented by a Bluetooth protocol (e.g., Bluetooth Classic, Bluetooth Low Energy (“LE”), etc.) and/or any other suitable communication protocol to facilitate communications between hearing device 202 and computing device 206. Communications between hearing device 202, computing device 206, and any other device/system may be transported using any one of the above-listed networks, or any combination or sub-combination of the above-listed networks.

System 100 may be implemented by computing device 206 or hearing device 202. Alternatively, system 100 may be distributed across computing device 206 and hearing device 202, or distributed across computing device 206, hearing device 202, and/or any other suitable computing system/device.

Hearing device 202 may be configured to provide one or more voice notifications to user 204 during use of hearing device 202. Such voice notifications may be used to inform user 204 regarding a status of hearing device 202, a status of another device communicatively coupled to hearing device 202, and/or for any other suitable purpose. To illustrate an example, an exemplary voice notification may include hearing device 202 playing a message indicating that “your hearing device battery is low” to inform user 204 that a battery of hearing device 202 needs to be charged. In certain examples, the voice notifications may be presented to user 204 by way of hearing device 202 using a particular type of voice. For example, either a male type of voice or a female type of voice may be used to present the voice notifications to user 204 by way of hearing device 202. However, certain users may have difficulty understanding voice notifications due to their limited hearing capacity. For example, the type of voice used for a voice notification may make a voice notification difficult for certain users to understand. To illustrate, a user with hearing loss in the low frequency range may have more difficulty hearing and/or understanding a voice notification that uses a male type of voice as opposed to a female type of voice. Alternatively, a user with hearing loss in the high frequency range may have more difficulty hearing and/or understanding a voice notification that uses a female type of voice as opposed to a male type of voice. Accordingly, system 100 may be configured to perform one or more processing operations to optimize voice notifications provided to user 204 by way of hearing device 202.

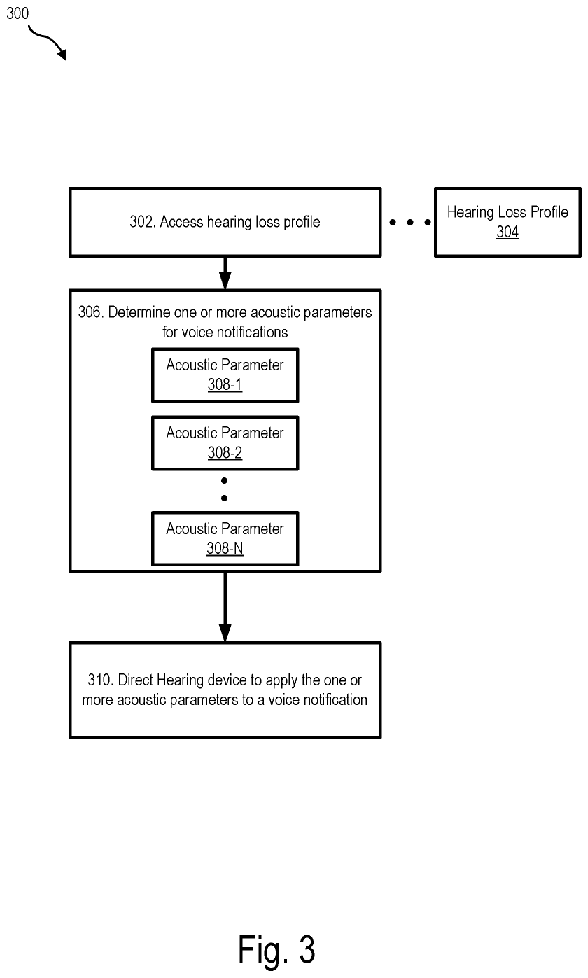

To illustrate, FIG. 3 shows an exemplary flow diagram 300 that depicts a flow of operations that may be performed by system 100 (e.g., computing device 206) to optimize voice notifications. As shown in FIG. 3, at operation 302, system 100 may access a hearing loss profile 304 of a user such as user 204. The hearing loss profile 304 may include any suitable information associated with hearing capabilities of user 204, fitting parameters used to fit hearing device 202 to user 204, current settings of hearing device 202, and/or hearing preferences of user 204. For example, hearing loss profile 304 may include information associated with a hearing impairment type of user 204, an amount of hearing impairment of user 204, an audiogram of user 204, and/or any other suitable information. System 100 may access hearing loss profile 304 in any suitable manner. For example, system 100 may communicate in any suitable manner with hearing device 202 to access hearing loss profile 304 of user 204 from memory 210. Additionally or alternatively, in certain examples, hearing loss profile 304 of user 204 may be stored in a memory of computing device 206 and/or at any other suitable location.

At operation 306, system 100 may determine, based on hearing loss profile 304, one or more acoustic parameters 308 (e.g., acoustic parameters 308-1 through 308-N) for voice notifications that may be presented by way of hearing device 202 to user 204. Acoustic parameters 308 may correspond to any suitable attribute of a voice notification that may affect the perceptibility of the voice notification for user 204. For example, acoustic parameters 308 may include one or more of a pitch, a speed, a frequency band gain, and/or a tone associated with a voice notification. In such examples, the determining of acoustic parameters 308 may include system 100 selecting, based on hearing loss profile 304, the pitch, the speed, the frequency band gain, and/or the tone to use for the voice notification to optimize the voice notification for user 204.

Additionally or alternatively, acoustic parameters 308 may include a plurality of voice type options that may alternatively be used for voice notifications. For example, acoustic parameters 308 may include a first voice type option, a second voice type option, and a third voice type option for voice notifications. In such examples, the determining of acoustic parameters 308 at operation 306 may include system 100 selecting, based on hearing loss profile 304, either the first voice type option, the second voice type option, or the third voice type option for use in presenting voice notifications to user 204 by way of hearing device 202. Voice type options such as those described herein may have any suitable attribute as may serve a particular implementation. For example, voice type options may have different accents and/or may be associated with different gender types in certain implementations. For example, the first voice type option may correspond to a male type of voice, the second voice type option may correspond to a female type of voice, and the third voice type option may correspond to a gender-neutral type voice option.

At operation 310, system 100 may direct hearing device 202 to apply one or more of acoustic parameters 308 to a voice notification to be presented to user 204 by way of hearing device 202. The one or more acoustic parameters 308 may be applied to a voice notification in any suitable manner. For example, in certain implementations, the applying of acoustic parameters 308 to a voice notification may include system 100 selecting a particular voice type option based on hearing loss profile 304. For example, hearing loss profile 304 may indicate that user 204 has difficulty hearing low frequency sounds. Based on such information, system 100 may automatically select a female type of voice to be used for voice notifications to be provided by way of hearing device 202 to user 204. Alternatively, hearing loss profile 304 may indicate that user 204 has difficulty hearing high frequency sounds. Based on such information, system 100 may automatically select a male type of voice to be used for voice notifications to be provided to user 204 by way of hearing device 202.

In certain examples, the applying of one or more of acoustic parameters 308 may include system 100 modifying a voice notification based on acoustic parameters 308 determined at operation 306. For example, system 100 may modify the pitch, the speed, the frequency band gain, the tone, and/or any other suitable acoustic parameter associated with voice notifications to improve perceptibility of voice notifications for user 204. In certain examples, such a modification may be made by system 100 in addition to a selection of a type of voice option for the voice notifications. For example, system 100 may select, based on hearing loss profile 304, a female type of voice for the voice notifications and may further modify the pitch, the speed, the frequency band gain, the tone, and/or any other suitable acoustic parameter associated with voice notifications to optimize the female type of voice and improve perceptibility of the voice notifications for user 204.

In certain examples, hearing device 202 may be configured to apply acoustic parameters 308 determined at operation 306 to a voice notification each time the voice notification is to be presented to user 204. For example, if hearing device 202 needs servicing, hearing device 202 may access voice notification from memory 210 that states “please submit your hearing device for servicing” and may modify one or more acoustic parameters (e.g., pitch, speed, etc.) of the voice notification to optimize the voice notification for user 204. Alternatively, in certain examples, voice notifications may be stored by hearing device 202 in a state where acoustic parameters have already been applied. For example, during a fitting session at a hearing care facility, system 100 may generate a set of notifications based on hearing profile 304 and acoustic parameters 308 and store the set of notifications in memory 210 of hearing device 202. During use, hearing device 202 may then access the set of notifications for use at any suitable time from memory 210 to provide optimized voice notifications to user 204. In such examples, only voice notifications that are optimized for user 204 may be stored in memory 210. Such an approach may be beneficial in instances where hearing device 202 only has sufficient storage for a limited amount of voice notifications (e.g., hearing device 202 may be limited to 35 seconds of voice notification).

Over time, the hearing capacity of user 204 may change. This change in hearing capacity may be due to progressive hearing loss and/or may be the result of a temporary illness of user 204. Such a change in hearing capacity may cause a change in hearing loss profile 304 of user 204 and may negatively affect the perceptibility of voice notifications for user 204. Accordingly, in certain examples, system 100 may be configured to monitor whether there have been any changes in hearing loss profile 304. This may be accomplished in any suitable manner.

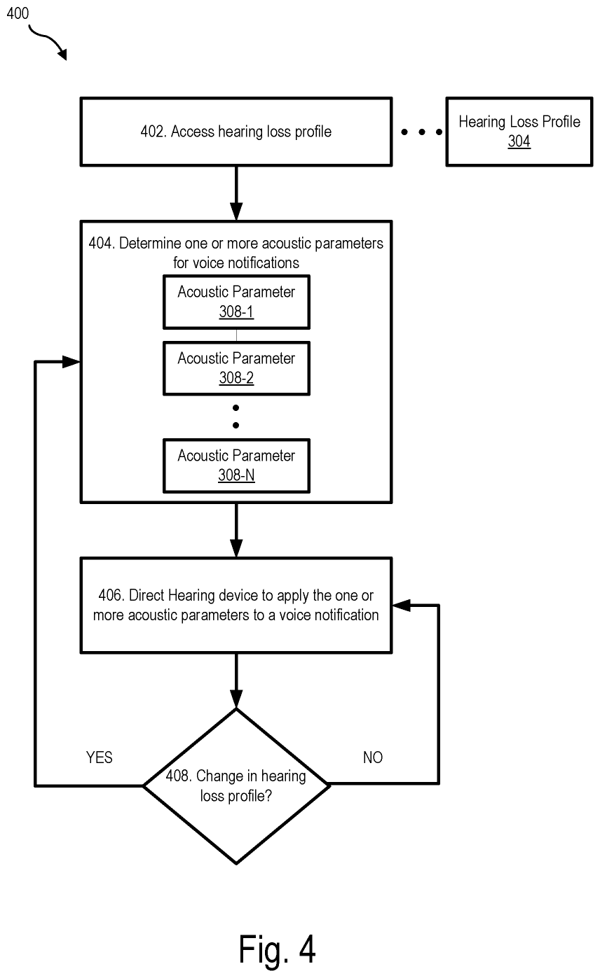

To illustrate, FIG. 4 shows an exemplary flow diagram 400 that depicts a flow of operations that may be performed by system 100 (e.g., computing device 206) to optimize voice notifications. As shown in FIG. 4, at operation 402, system 100 may access hearing loss profile 304 in any suitable manner such as described herein. At operation 404, system 100 may determine, based on hearing loss profile 304, one or more acoustic parameters 308 for voice notifications. Operation 404 may be performed in any suitable manner such as described herein. At operation 406, system 100 may direct hearing device 202 to apply the one or more acoustic parameters to a voice notification to be provided by way of hearing device 202 to user 204. Operation 406 may be performed in any suitable manner such as described herein.

At operation 408, system 100 may determine whether there has been a change in hearing loss profile 304. This may be accomplished in any suitable manner. For example, one or more fitting operations may be performed during a fitting session to determine whether the hearing capacity of user 204 has changed. Alternatively, hearing device 202 may be configured to monitor the hearing capacity of user 204 during use of hearing device 202 and may determine, in any suitable manner, whether there has been a change in the hearing capacity of user 204. If the answer at operation 408 is “NO,” the flow may revert to operation 406 and hearing device 202 may continue to apply the previously determined acoustic parameters to voice notifications provided by way of hearing device 202. If the answer at operation 408 is “YES,” the flow may return to operation 404 and system 100 may determine, based on the change in hearing loss profile 304 of user 204, one or more additional acoustic parameters 308 for the voice notifications. The flow may then repeat operation 406 and direct hearing device 202 to apply the one or more additional acoustic parameters 308 to a voice notification.

System 100 may repeat operations 404-408 any suitable number of times to optimize voice notifications provided by way of hearing device 202 to user 204.

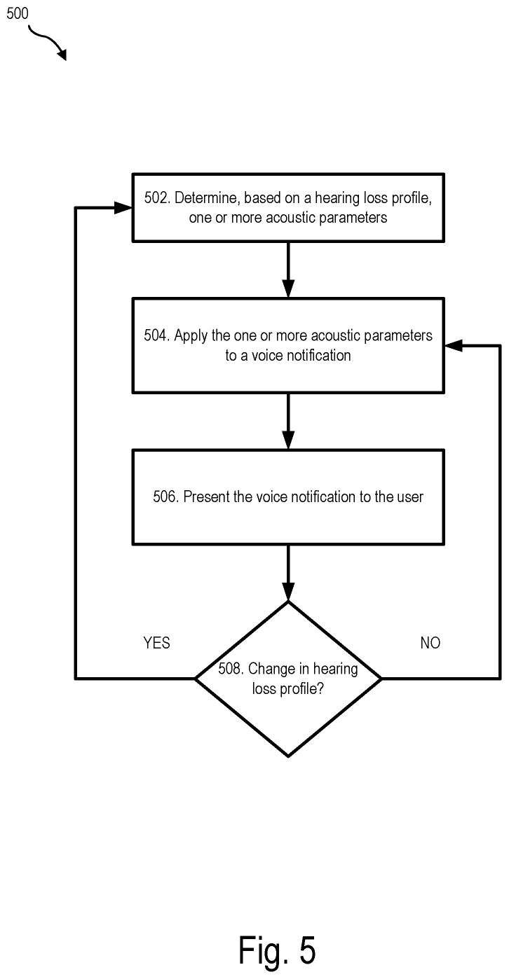

FIG. 5 shows another exemplary flow diagram 500 that depicts a flow of operations that may be performed by system 100 (e.g., hearing device 202) to optimize voice notifications. As shown in FIG. 5, at operation 502, system 100 may determine, based on a hearing loss profile of a user (e.g., hearing loss profile 304), one or more acoustic parameters (e.g., acoustic parameters 308) to be used for voice notifications. This may be accomplished in any suitable manner such as described herein.

At operation 504, system 100 may apply the acoustic parameters determined at operation 502 to a voice notification. This may be accomplished in any suitable manner such as described herein.

At operation 506, system 100 may present the voice notification to user 204. Operation 506 may be accomplished in any suitable manner. For example, hearing device 202 may acoustically present the voice notification to user 204 by way of a speaker in an ITE component of hearing device 202.

At operation 508, system 100 may determine whether there has been a change in the hearing loss profile of the user. If the answer at operation 508 is “NO,” the flow may continue to operation 504 and system 100 may continue to apply one or more acoustic parameters to the voice notification. If the answer at operation 508 is “YES,” the flow may return to operation 502 and system 100 may determine, based on the change in the hearing loss profile, an additional one or more acoustic parameters for the voice notification. System 100 may then repeat operations 502-508 any suitable number of times to optimize voice notifications provided by way of hearing device 202 to user 204.

In certain examples, system 100 may facilitate a user (e.g., user 204) selecting a voice type option for use in providing voice notifications to the user by way of a hearing device. In such examples, system 100 may be configured to receive a user input selecting the voice type option in any suitable manner. For example, a user input selecting a voice type option may be received by system 100 by way of a user interface during a fitting procedure performed by a hearing care professional. Alternatively, such a user-selected voice type option may be received by way of any suitable interface associated with hearing device 202 during use of hearing device 202. To illustrate an example, user 204 of hearing device 202 may select a gender-neutral voice type or a character voice type (e.g., a Mickey Mouse voice, a Darth Vader voice, etc.) to be used for voice notifications. In such examples, system 100 may modify, based on the hearing loss profile of the user, one or more acoustic parameters of the selected gender-neutral or character voice type to optimize voice notifications for the user.

In certain examples, a voice notification may be transmitted, during use of a hearing device, to the hearing device from an external device that is communicatively coupled to the hearing device. In such examples, the directing of the hearing device to apply one or more acoustic parameters to a voice notification may include the hearing device modifying the voice notification transmitted from the external device based on the one or more acoustic parameters. To illustrate an example, in certain implementations, computing device 206 may correspond to a smartphone of user 204 that is communicatively coupled to hearing device 202. The smartphone may be configured to transmit voice notifications (e.g., Siri notifications) to hearing device 202 by way of network 208 (e.g., by way of a Bluetooth connection). In such examples, system 100 may be configured to modify, based on the hearing loss profile of the user, the voice notifications transmitted from the smartphone in any suitable manner to improve the perceptibility of the voice notifications for user 204.

In certain examples, system 100 may facilitate generating a set of acoustic parameters for each of a plurality of different hearing loss types to optimize voice notifications for users having different hearing loss types. For example, system 100 may determine a first set of acoustic parameters for users that have a first hearing loss type, a second set of acoustic parameters for users that have a second hearing loss type, and a third set of acoustic parameters for users that have a third hearing loss type.

System 100 may determine which set of acoustic parameters is best suited for a particular hearing loss type in any suitable manner. For example, DNN chips may be used to generate pre-defined sets of acoustic parameters for different hearing loss types. In such examples, hearing device 202 may include one or more DNN chips to facilitate optimizing voice notifications provided by way of hearing device 202. Such DNN chips may be configured to implement a machine learning model to determine the sets of acoustic parameters. In certain examples, a machine learning model may access setting information of multiple different users with DNN chips in the hearing devices and compare and learn from the settings information to create sets of acoustic parameters for different hearing loss types. System 100 may implement any suitable type of machine learning methodology as may serve a particular implementation. For example, in certain implementations, a machine learning model may implement a DNN, a convolutional network (“CNN”), a Kalman filter, a Markov model, and/or a Bayesian network to determine sets of acoustic parameters to use for voice notifications.

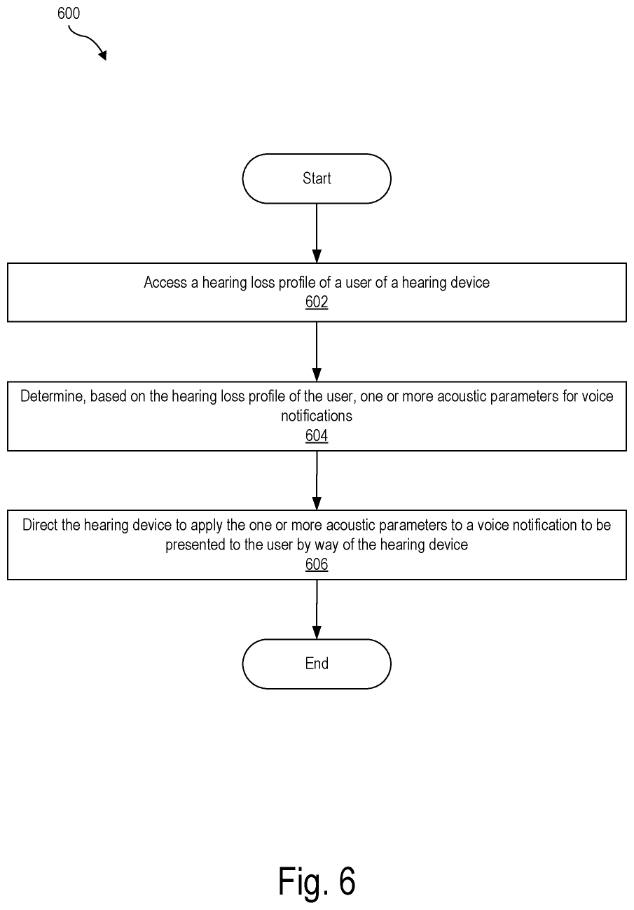

FIG. 6 illustrates an exemplary method 600 for optimizing voice notifications provided by way of a hearing device according to principles described herein. While FIG. 6 illustrates exemplary operations according to one embodiment, other embodiments may omit, add to, reorder, and/or modify any of the operations shown in FIG. 6. One or more of the operations shown in FIG. 6 may be performed by a hearing device such as hearing device 202, a computing device such as computing device 206, an additional computing device communicatively coupled to computing device 206 and/or hearing device 202, any components included therein, and/or any combination or implementation thereof.

At operation 602, a hearing device management system such as hearing device management system 100 may access a hearing loss profile of a user of a hearing device. Operation 602 may be performed in any of the ways described herein.

At operation 604, the hearing device management system may determine, based on the hearing loss profile of the user, one or more acoustic parameters for voice notifications. Operation 604 may be performed in any of the ways described herein.

At operation 606, the hearing device management system may direct the hearing device to apply the one or more acoustic parameters to a voice notification to be presented to the user by way of the hearing device. Operation 606 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

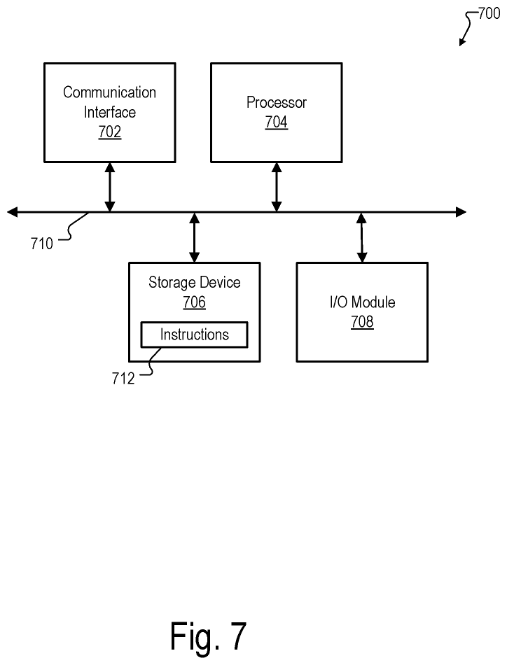

FIG. 7 illustrates an exemplary computing device 700 that may be specifically configured to perform one or more of the processes described herein. As shown in FIG. 7, computing device 700 may include a communication interface 702, a processor 704, a storage device 706, and an input/output (“I/O”) module 708 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of the non-volatile media and/or volatile media described herein. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 700. For example, memory 102 and/or memory 210 may be implemented by storage device 706, and processor 104 and/or processor 212 may be implemented by processor 704.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a memory that stores instructions; and
a processor communicatively coupled to the memory and configured to execute the instructions to perform a process comprising:
accessing a hearing loss profile of a user of a hearing device;
determining, based on the hearing loss profile of the user, one or more acoustic parameters for voice notifications; and
directing the hearing device to apply the one or more acoustic parameters to a voice notification to be presented to the user by way of the hearing device.

2. The system of claim 1, wherein the process further comprises:
detecting a change in the hearing loss profile of the user;
determining, based on the change in the hearing loss profile of the user, one or more additional acoustic parameters for the voice notifications; and
directing the hearing device to apply the one or more additional acoustic parameters to the voice notification to be presented to the user by way of the hearing device.

3. The system of claim 1, wherein the directing of the hearing device to apply the one or more acoustic parameters to the voice notification includes modifying the voice notification based on the one or more acoustic parameters.

4. The system of claim 1, wherein the one or more acoustic parameters for the voice notifications include at least one of pitch, speed, frequency band gain, or tone.

5. The system of claim 1, wherein:
the one or more acoustic parameters include a first voice type option and a second voice type option for the voice notification; and
the determining of the one or more acoustic parameters includes selecting, based on the hearing loss profile of the user, either the first voice type option or the second voice type option for use in presenting the voice notifications to the user by way of the hearing device.

6. The system of claim 5, wherein:
the first voice type option corresponds to a male type of voice; and
the second voice type option corresponds to a female type of voice.

7. The system of claim 1, wherein the process further comprises:
receiving a user input selecting a voice type option for use in providing the voice notifications to the user by way of the hearing device; and
directing the hearing device to use the voice type option selected by the user for the voice notification.

8. The system of claim 7, wherein the directing of the hearing device to apply the one or more acoustic parameters to the voice notification further includes directing the hearing device to modify the voice notification based on the one or more acoustic parameters and the voice type option selected by the user.

9. The system of claim 1, wherein:
the voice notification is transmitted, during use of the hearing device, to the hearing device from an external device that is communicatively coupled to the hearing device; and
the directing of the hearing device to apply the one or more acoustic parameters to the voice notification includes modifying the voice notification transmitted from the external device based on the one or more acoustic parameters.

10. A hearing device comprising:
a memory that stores instructions; and
a processor communicatively coupled to the memory and configured to execute the instructions to perform a process comprising:
determining, based on a hearing loss profile of a user of the hearing device, one or more acoustic parameters for voice notifications;
applying the one or more acoustic parameters to a voice notification; and
presenting the voice notification to the user subsequent to applying the one or more acoustic parameters to the voice notification.

11. The hearing device of claim 10, wherein the process further comprises:
detecting a change in the hearing loss profile of the user of the hearing device;
determining, based on the change in the hearing loss profile of the user, one or more additional acoustic parameters for the voice notifications; and
directing the hearing device to apply the one or more additional acoustic parameters to the voice notification.

12. The hearing device of claim 10, wherein:
the one or more acoustic parameters include a first voice type option and a second voice type option for the voice notifications; and
the determining of the one or more acoustic parameters includes selecting, based on the hearing loss profile of the user, either the first voice type option or the second voice type option for use in presenting the voice notifications to the user by way of the hearing device.

13. The hearing device of claim 12, wherein:
the first voice type option corresponds to a male type of voice; and
the second voice type option corresponds to a female type of voice.

14. The hearing device of claim 10, wherein:
the voice notification is transmitted, during use of the hearing device, to the hearing device from an external device that is communicatively coupled to the hearing device; and
the applying of the one or more acoustic parameters to the voice notification includes modifying the voice notification transmitted from the external device based on the one or more acoustic parameters.

15. The hearing device of claim 10, wherein the voice notifications are stored in the memory of the hearing device.

16. A method comprising:
accessing, by a hearing device management system, a hearing loss profile of a user of a hearing device;
determining, by the hearing device management system and based on the hearing loss profile of the user, one or more acoustic parameters for voice notifications; and
directing, by the hearing device management system, the hearing device to apply the one or more acoustic parameters to a voice notification to be presented to the user by way of the hearing device.

17. The method of claim 16, wherein the method further comprises:
detecting, by the hearing device management system, a change in the hearing loss profile of the user of the hearing device;
determining, by the hearing device management system and based on the change in the hearing loss profile of the user, one or more additional acoustic parameters for the voice notifications; and
directing, by the hearing device management system, the hearing device to apply the one or more additional acoustic parameters to the voice notification to be presented to the user by way of the hearing device.

18. The method of claim 16, wherein:
the one or more acoustic parameters include a first voice type option and a second voice type option for the voice notifications; and
the determining of the one or more acoustic parameters includes selecting, based on the hearing loss profile of the user, either the first voice type option or the second voice type option for use in presenting the voice notifications to the user by way of the hearing device.

19. The method of claim 18, wherein:
the first voice type option corresponds to a male type of voice; and
the second voice type option corresponds to a female type of voice.

20. The method of claim 16, wherein:
the one or more acoustic parameters for the voice notifications include at least one of pitch, speed, frequency band gain, or tone; and
the directing of the hearing device to apply the one or more acoustic parameters to the voice notification includes modifying the at least one of the pitch, the speed, the frequency band gain, or the tone of the voice notification.
